(19) United States
(12) Patent Application Publication
(10) Pub. No.: US 2026/0228984 A1
(43) Pub. Date: Aug. 6, 2026

(54) GUIDED ELECTRIC VEHICLE CHARGING INSTALLATION USING EXTENDED REALITY

(71) Applicant: Florida Power & Light Company, Juno Beach, FL (US)

(72) Inventors: Lawrence J. Oks, Palm Beach Gardens, FL (US); Kara L. Fuller, Hobe Sound, FL (US); Ariel S. Polani, Jupiter, FL (US)

(21) Appl. No.: 19/045,236

(22) Filed: Feb. 4, 2025

(51) Int. Cl. G06T 19/00; G06Q 30/0283; G06T 7/60; G06V 20/20

(52) U.S. Cl. CPC G06T 19/006; G06Q 30/0283; G06T 7/60; G06V 20/20

(57) ABSTRACT

A system and a computer-implemented method evaluates EV charging station installations for EV vehicles in extended reality (XR) spaces. The method processes 3D coordinate data of a parking area, paired with real-world images, to analyze the environment. Object recognition identifies key features like walls, electrical panels, and ceilings while measuring wall dimensions and electrical panel distances. The method also retrieves the electrical capacity of electrical panels. The method generates potential charger positions along walls, scoring each based on breaker distance, wiring cost, and clearance from surrounding objects. The evaluation identifies the position with the highest score, optimizing for installation feasibility and cost-efficiency. Using XR technology, the system creates a 3D preview of the optimal charger position by overlaying computer-generated visuals onto the real-world space. This preview, incorporating spatial data and realistic imagery, is presented to users, enabling informed decisions on installation placement while reducing planning time and errors.

### FIELD OF THE DISCLOSURE

The present disclosure generally relates to an extended reality system for guiding and managing the installation of electric vehicle chargers.

### BACKGROUND

Planning the installation of an electric vehicle (EV) charger requires a comprehensive evaluation of the electrical panel, layout, and space requirements. The charger should be installed near the vehicle's regular parking spot to ensure optimal functionality and safety. This minimizes the distance to the charging port, reducing the need for long cables and allowing standard-length cables to reach easily. Such placement enhances convenience and minimizes potential hazards for the user.

Adequate wall space is crucial to securely mount the charger at an accessible height, enabling effortless cable handling for plugging and unplugging. Additionally, proper clearance around the charger must be maintained to prevent obstructions and ensure adequate ventilation, supporting safe heat dissipation during operation.

The current manual process for assessing EV charger installation sites is inefficient and costly. Customers are required to upload photos of their garages or other intended installation areas, which are then manually reviewed by employees to determine suitability. This process introduces significant delays, leaving customers waiting for feedback and increasing the company's operational expenses.

Moreover, customers do not receive visual representations of the potential installation, adding uncertainty to the process and detracting from their overall experience.

### SUMMARY OF THE INVENTION

Aspects of the present invention overcome the challenges described above with the prior art to provide a streamlined, automated solution. The system disclosed enhances efficiency, reduces delays, improves customer satisfaction, and elevates the overall experience by providing visual examples and faster feedback.

More specifically, a system and a computer-implemented method is disclosed for evaluating an electric vehicle (EV) charging station installation in an extended reality space, which comprises several steps. The method begins by accessing a collection of data points in a 3D coordinate system that represents the 3D shape of at least one parking area intended for EV charging, wherein each data point corresponds to a spatial measurement. Light Detection and Ranging (LiDAR) may be used to capture the collection of data points in 3D. Additionally, the method involves accessing at least one image of the real-world parking area and using object recognition to identify surrounding objects within the image, including walls, electrical panels, and ceilings. Dimensions of the identified walls and their relative distances to the electrical panel are measured, and the electrical capacity information for the panel is accessed.

Next, a set of potential installation positions is created along the identified walls. A charging station is placed in an evaluation position within this set, and an overall score is calculated for the position. This scoring involves determining the breaker distance between the evaluation position and the identified electrical panel or breaker panel, estimating the cost based on the amount of wiring required to traverse this breaker distance, and calculating the clearance distance between the evaluation position and identified surrounding objects. These parameters—the breaker distance, estimated cost, and clearance distance—are stored as overall scores associated with the evaluation position.

The method proceeds by identifying the evaluation position with the highest overall score. Using extended reality technology, a 3D preview of this position is generated by combining at least one computer-generated image of the charging station with the data points from the 3D coordinate system. Finally, the method concludes by presenting the 3D preview of the evaluation position to a user.

The disclosed system evaluates charging station installations for EV vehicles using an extended reality (XR) space. The method includes accessing 3D coordinate data points, such as LiDAR, representing the parking area's shape, combined with real-world images.

To streamline the EV charger installation process, the system employs object recognition to identify key elements like walls, electrical panels, and ceilings from uploaded images. The system automatically measures wall dimensions, determines distances to electrical panels, and evaluates electrical panel capacity. Users can label objects in images to improve recognition accuracy.

The system also detects electrical panel models through image analysis to assess amperage capacity and examines open-panel images to identify available breaker slots. Multiple potential charger positions are analyzed and scored based on factors like parking distance, breaker distance, wiring costs, and clearance. Positions failing to meet clearance or electrical requirements are automatically excluded.

The highest-scoring position is selected, and users are presented with an XR-generated 3D preview that merges real-world images with 3D data for a realistic visualization. Additionally, the system compares multiple installation options by showing requirements and costs for each, empowering users to make informed decisions.

### BRIEF DESCRIPTION OF THE DRAWINGS

The accompanying figures, where like reference numerals refer to identical or functionally similar elements throughout the separate views, and which together with the detailed description below are incorporated in and form part of the specification, serve to further illustrate various embodiments and to explain various principles and advantages all in accordance with the present disclosure, in which:

FIG. 1 depicts an equipment image capture environment, according to an example;

FIG. 2 depicts a block diagram of various methods of accessing specific energy information from an object related to energy consumption, according to an example;

FIG. 3 depicts an illustration of an EV vehicle in a garage being charged with an EV charger, according to an example;

FIG. 4 depicts an illustration of an EV charger installed on a garage wall, according to an example;

FIG. 5, FIG. 6 and FIG. 7 illustrates a process flow for guided EV charging installation, according to an example; and

FIG. 8 depicts a block diagram illustrating a processor to implement the process and system described above, according to an example.

### DETAILED DESCRIPTION

As required, detailed embodiments are disclosed herein; however, it is to be understood that the disclosed embodiments are merely examples and that the systems and methods described below can be embodied in various forms. Therefore, specific structural and functional details disclosed herein are not to be interpreted as limiting but merely as a basis for the claims and as a representative basis for teaching one skilled in the art to variously employ the disclosed subject matter in virtually any appropriately detailed structure and function. Further, the terms and phrases used herein are not intended to be limiting, but rather to provide an understandable description.

### Non-limiting Definitions

The term “3D measurements” refers to measurements, typically non-contact measurements, taken of an object to create a three-dimensional (3D) point cloud of an object that is dimensionally accurate and a photorealistic model of the object, such as through photogrammetry.

The terms “a” or “an”, as used herein, are defined as one or more than one. The term plurality, as used herein, is defined as two or more than two.

The term “adapted to” describes the hardware, software, or a combination of hardware and software that is capable of, able to accommodate, or that is suitable to carry out a given function.

The term “another”, as used herein, is defined as at least a second or more.

The terms “camera” and “displays” are terms of convenience but do nevertheless describe an ordinary cell phone. A camera can be expanded to include any form of directional identification of the appliance—Optics, LiDAR, RFID, NFC, etc. and the display can be a cell phone with or without displaying augmentation of the appliance or a hand-held or head-worn stereoscopic display. Also, the information displayed can include both smart meter and cloud-based appliance information.

The term “class” or “classifier” or “label” is a class label applied to data input in a machine learning algorithm.

The term “configured to” describes hardware, software, or a combination of hardware and software that is adapted to, set up, arranged, built, composed, constructed, designed, or that has any combination of these characteristics to carry out a given function.

The term “computer-generated image” means computer-generated image content brought into a real-world image to augment it, creating a computer-generated image.

The term “control” refers to direct or indirect communication between a user and a device utilizing a wired or wireless interface. This communication enables the user to adjust the device's energy consumption. The user can control the device using one or more of eye movements, hand gestures, and speech.

The term “coupled,” as used herein, is defined as “connected,” although not necessarily directly and not necessarily mechanically.

The term “energy consumption” as used herein, means related to the use of energy sources, including electricity, natural gas, oil, and includes both renewable and non-renewal sources of energy. Energy consumption can be specific to a device being viewed or generic, such as information that is applicable to all similar make and model numbers of the device.

The term “extended reality” is an umbrella term for all immersive technologies, including augmented reality (AR), virtual reality (VR), and mixed reality (MR).

The term “generic energy information” means general energy information, typically from a manufacturer or other agency for a given family or model of objects related to energy savings.

The terms “including” and “having,” as used herein, are defined as comprising (i.e., open language).

The term “image” refers to a spatial pattern of physical light comprised of known colors of the light spectrum, which may or may not be visible to the human eye. The term image includes both real-world images, such as a live view through a camera, as well as a virtual representation of a space.

The term “image editing software” means software for editing and manipulating images, such as Blender.org or Photoshop® from Adobe Inc.

The term “or” is intended to mean an inclusive “or” rather than an exclusive “or.” That is, unless specified otherwise or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

The term “object related to energy consumption” means insulation in walls, attic, foundation, hot water equipment, ventilation, smart thermostats, LEDs, smart power strips, appliances, solar hot water, solar photoelectric, electric vehicle chargers, window tint, replacement windows, and other energy-efficient technologies that improve energy savings and provide a reduction in a carbon footprint.

The term “photogrammetry” is a technique to extract three-dimensional measurements of an object to obtain reliable information, such as three-dimensional measurements, through processing and interpreting a series of photographic images. Photogrammetry may be complemented by techniques like LiDAR, laser scanners (using time of flight, triangulation or interferometry), white-light digitizers and any other technique that scans an area and returns x, y, z coordinates for multiple discrete points, commonly called “point clouds”.

The term “real-world” means existing in reality, as opposed to one that is virtual, imaginary, simulated, theoretical or a computer-generated image.

The term “specific energy information” means energy information measured, whether real-time or historical data, and whether directly or inferred through a smart meter, for specific objects related to energy consumption in a real-world space, typically appliances and other items or objects related to energy consumption.

The term “synthetic” means creating a computer-generated composite image combining computer-generated images with real-world images.

The term “variable attributes” means a changeable characteristic of a specific object in a family of objects that may be different from other objects in the same family of objects.

The term “uniform data format” means data in a given format, whether date format, time format, currency format, scientific format, text format, or fractional format, so that all values of data are presented in a single consistent format for a given category or criteria.

It should be understood that the steps of the methods set forth herein are not necessarily required to be performed in the order described, and the order of the steps of such methods should be understood to be merely exemplary. Likewise, additional steps may be included in such methods, and certain steps may be omitted or combined in methods consistent with various embodiments of the present device.

### Overview

Proper EV charger installation must meet several critical requirements. These include ensuring that the charger can be installed within a reasonable distance from the main electrical panel, as the wiring must connect directly to the panel while complying with local codes, standards, and manufacturer specifications. The electrical panel must have sufficient space to accommodate an additional dedicated circuit, which typically requires 240 volts for Level 2 chargers. Level 2 chargers are preferred due to their significantly faster charging capabilities compared to standard Level 1 chargers. Additionally, the existing electrical panel must have enough capacity to handle the added load without risking an overload of the system.

Safety is a top priority during the installation of EV charging equipment. Ensuring proper ventilation in the garage is essential for managing the heat generated by the charging system. The installation area should be kept clear of clutter and obstacles to allow for adequate airflow. This not only prevents overheating but also helps extend the lifespan of the equipment.

Additionally, it is crucial to adhere to local, state, and federal building and electrical codes. These codes typically specify the minimum and maximum allowable heights for mounting chargers, the necessary clearances from surrounding structures, and the protective measures needed to mitigate the risk of accidental damage or electrical hazards.

Accessibility and convenience are crucial factors in the design and installation of an EV charger. The charger should be placed in a location that allows easy access without major obstructions, ensuring that the charging cable can easily reach the vehicle's charging port. This consideration helps prevent undue strain on the cable, reducing the risk of damage over time.

Planning for the potential integration of future charger technologies is an important consideration. As EV technology and charging infrastructure continue to advance, planning for possible upgrades is wise. This may involve installing conduits to accommodate future wiring needs, considering dual chargers for households with multiple EVs, or plans to expand EV chargers. Taking a forward-thinking approach can help reduce time and costs related to future modifications, ensuring the charging setup remains efficient and compatible with evolving technologies. Carefully planning and adhering to these considerations, the claimed invention provides a safe, functional, and user-friendly EV charging installation guidance.

### Operating Environment

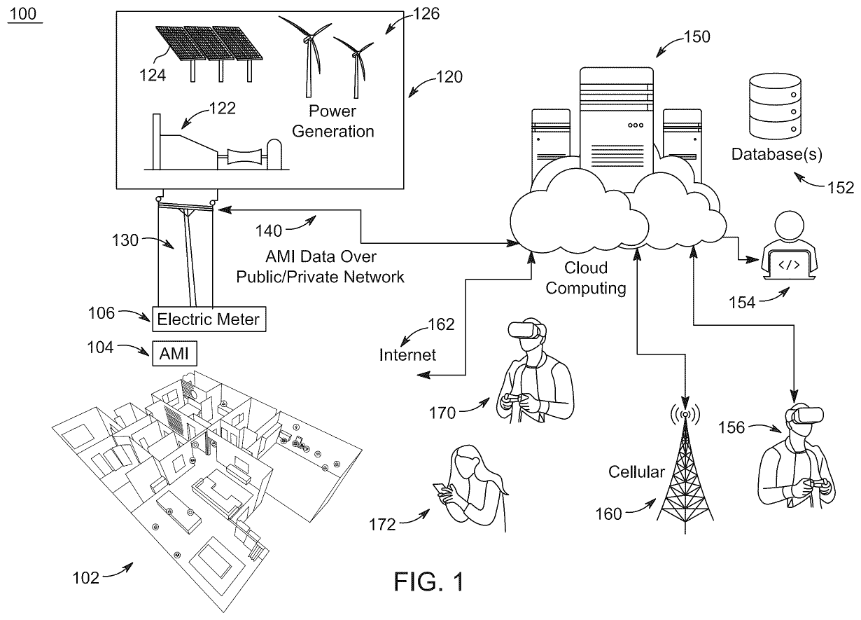

FIG. 1 depicts one example of an operating environment 100 for performing an interactive energy assessment, including an electrical power “grid” used to provide electrical power to consumer premises 102. The example shown in FIG. 1 depicts several examples of power generation components 120. Illustrated is a combined cycle gas generator 122, a solar array farm 124, and a wind farm 126. In further examples, operational contexts can include one power generation component, multiple collocated power generation components, power generation components that are physically separated and supply a common electrical power transmission or distribution system, any one or more power generation components, or combinations of these. The power generation components can be of any suitable type or design.

In this example, electrical power generated by one or more power generation components is provided to a power transmission system 130. The illustrated example depicts a transmission connection 130 that couples one or more sources within power generation components 120 to the consumer's premises 102. For simplicity, additional known transmission equipment is not shown as part of the transmission connection 130, such as suitable step-up transformers and long-distance transmission lines to convey the generated electrical power to remote power distribution networks and other electrical power consumers. A smart electric meter 106 is electrically coupled to the transmission connection 130 for the consumer's premises, as shown. In one example, the smart electric meter 106 is also electrically coupled to an advanced metering network (AMI) 104.

The electric meter 106 may include an AMI module 104 and a consumer's premises 102 interconnected through a smart grid, for example. In one embodiment, the AMI customer portal 154 provides customers with tools to compare monthly, daily, and hourly energy usage periods through a cloud computing platform 150. The customers may be able to access the data from database repository 152 on a real-time basis through the use of a wired network 162 to the consumer's premises 102 or wireless network 160. Alternatively, the data may be accessed in a near-real-time manner. The data may be collected by the AMI module 104 from a plurality of sources and then transmitted through the use of network 140 to the data repository 152. For example, the data may be collected from smart meters, Home Area Network (HAN) pricing, or any other component of the AMI. The system may also provide customers with analytical tools to be displayed/interacted with via mobile devices 170, 172, and computing device 154, as part of the extended reality experience. The analytical tools may be for at least a graphical, a tabular, a numerical analysis, or the like of the customer's anticipated energy usage and generation data. The system may also provide the customers with an analytical tool for at least a graphical, tabular, numerical analysis or the like of the customer's historical energy usage and energy generation data.

Optionally, the system may also have a plurality of widgets customized and/or customized for individual customers. For example, the widgets may be customized based on the customer profile, i.e., the type of energy sources, the usage data, the customer's preferences as to the usage of electricity, the customer's monitored usage habits, energy consumption data of the community where the customer is located, and the like. A user can have different user accounts, and each account can have a different profile. Also, a meter may be inquired remotely to see if power is down at the meter and not inside a customer's home. Thus, one customer may have a plurality of customized profiles, from which a customer may select a profile to apply at any given time. Additionally, the customer may be able to manage or communicate with individual electrical devices and appliances in their home.

For example, these systems may include hardware, software, communications interfaces, consumer energy displays and controllers, customer-associated systems, Meter Data Management (MDM) software, supplier business systems, and the like. In one embodiment, the system may be hardware-based, software-based, or any combination thereof.

Individual customer profiles may also show usage/consumption data that closely matches the usage information that will be sent to the customer in a bill. The subject matter disclosed herein enables a framework that helps develop reusable and extendable widgets. The subject matter disclosed herein may also enable a replicable portal that allows the addition of widgets. In one embodiment, a customer may be a residential user. Optionally, the customer may be a commercial user. A network may be a wired network or a wireless network 160.

Also shown are two power customers, 170 and 172. Power customer 170 uses an extended reality headset to experience or view an immersive interactive energy assessment. Power customer 172 is shown using a smartphone to experience or view an immersive interactive energy assessment, as further described below. The customers may be guided by an energy auditor 156 that is in the same virtual space of the customer premises 102 space but geographically separate. The energy auditor 156 can be a person using extended reality headsets or other displays like a smartphone or computer. The energy auditor 156 guides customers 80 and 82 through the customer's premises 102 to conduct the immersive interactive energy assessment.

In another example, the energy auditor 156 is an avatar that is programmatically created to guide customers 80 and 82 through the customer's premises 102. Tools to create avatars are available for free and can be purchased on platforms such as GitHub and Crunchbase.

In general, customer premises 102 coupled to the power distribution system 120 are able to include any combination of residential, commercial, or industrial buildings.

### Flow Diagram of Object Related to Energy Consumption

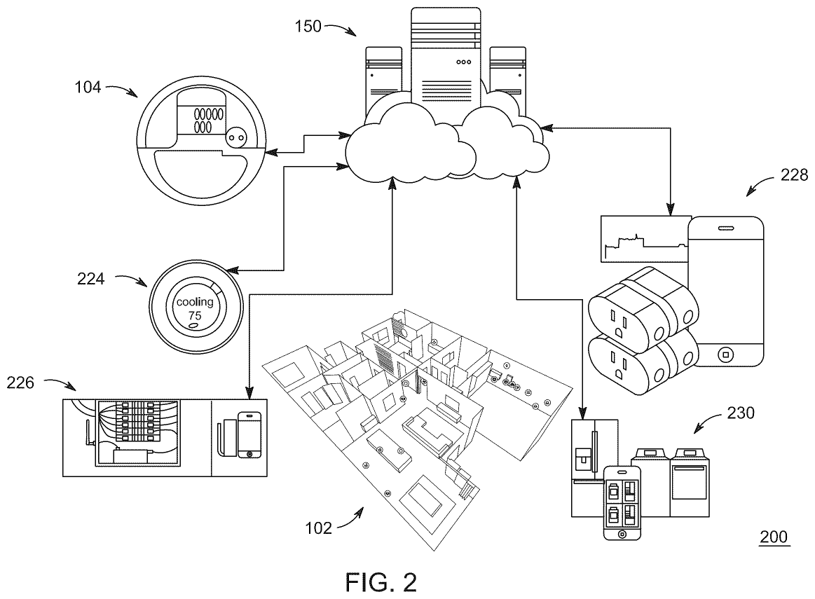

FIG. 2 depicts a block diagram 200 of various methods of accessing specific energy information from an object related to energy consumption. Customer premises 102, smart electric meter 106, and cloud computing platform 150 have been previously described above with reference to FIG. 1.

In addition to the smart electric meter 104, the other methods to access specific energy information for an identified object related to energy consumption include smart appliances 230, such as a washer, a dryer, and a refrigerator, which report their real-time or current energy usage. Also shown are smart plugs 228, which monitor the energy usage of an object plugged into it.

A smart thermostat 224 can report energy consumption from an HVAC system or systems. Home energy monitors 226, such as those available from Sense Labs, Inc. of Cambridge, Massachusetts, and others can report energy usage for a specific object in a household.

Devices that monitor energy usage, as shown in FIG. 2, can communicate back to the cloud computing platform 150 of FIG. 1 using the public/private network 140 through a wireless connection 160 or both.

### EV Charger Installation

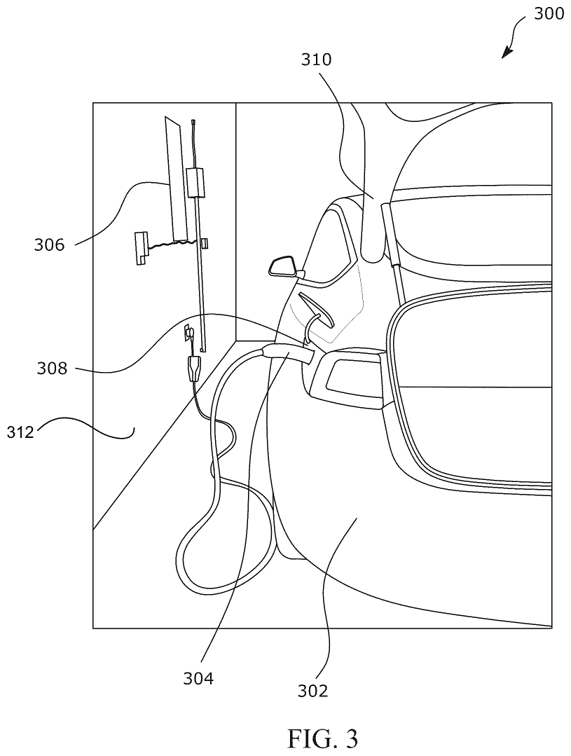

FIG. 3 depicts an illustration of an EV vehicle 302 in a garage 300. In this example, the tailgate or trunk 310 of the EV vehicle is in an open position. The EV vehicle 302 is being charged with an EV charger cable 304, electrically coupled to charging port 308. Also shown is an electrical panel 306 mounted on a wall 312.

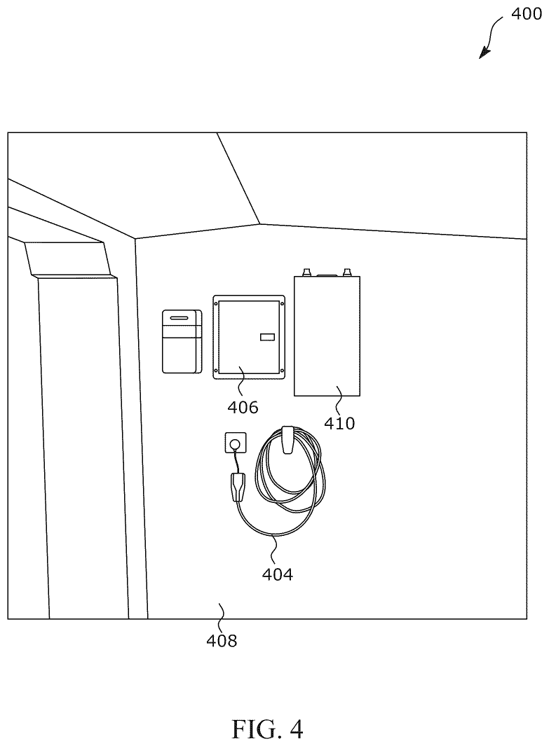

FIG. 4 depicts an illustration 400 of an EV charger 404 installed on a garage wall 408. An electrical panel 406 is mounted on the garage wall 408. EV power electronics 410 is shown mounted on the garage wall 408.

The claimed invention leverages LIDAR imagery from customers'phone cameras to capture precise measurements of parking areas. Wide-angle images provide an overview of the garage's layout, while close-up shots of electrical panels—both with the door open and closed—enable a detailed evaluation of the electrical panel's electrical capacity and the potential to add circuits.

Additional images capture obstructions such as shelves, tools, or other items near the proposed charger location, offering a clear understanding of spatial constraints. Where applicable, images of existing electrical setups further inform the analysis by providing insights into the current infrastructure.

The claimed invention integrates these measurements with AI and image recognition to analyze the images and identify the best locations for EV charger installation. Additionally, extended reality (XR) technology enables customers to view 3D previews of the charger setup in their parking space before installation, enhancing transparency and customer experience.

The claimed invention significantly improves upon current manual processes by automating eligibility analysis, enhancing customer experience, and increasing operational efficiency. One of the key advancements is time efficiency, as the automation reduces processing time from hours to mere seconds. Additionally, customer experience is greatly enhanced through the provision of 3D previews of the charger setup, eliminating the need to rely on static images or imagination. Operational productivity is also improved by enabling precise interior measurements, allowing installers to bring the necessary equipment on the first visit, thereby minimizing repeat trips and streamlining the supply chain. Furthermore, the invention delivers cost savings by reducing the need for manual reviews, which not only lowers expenses but also boosts employee satisfaction by removing tedious and repetitive tasks.

Aspects of the invention utilize a brute force approach when the solution space is sufficiently small, such as evaluating all possible wall locations for the charger. This method ensures the accurate identification of the most feasible installation spot while maintaining computational simplicity, avoiding the need for more complex optimization techniques.

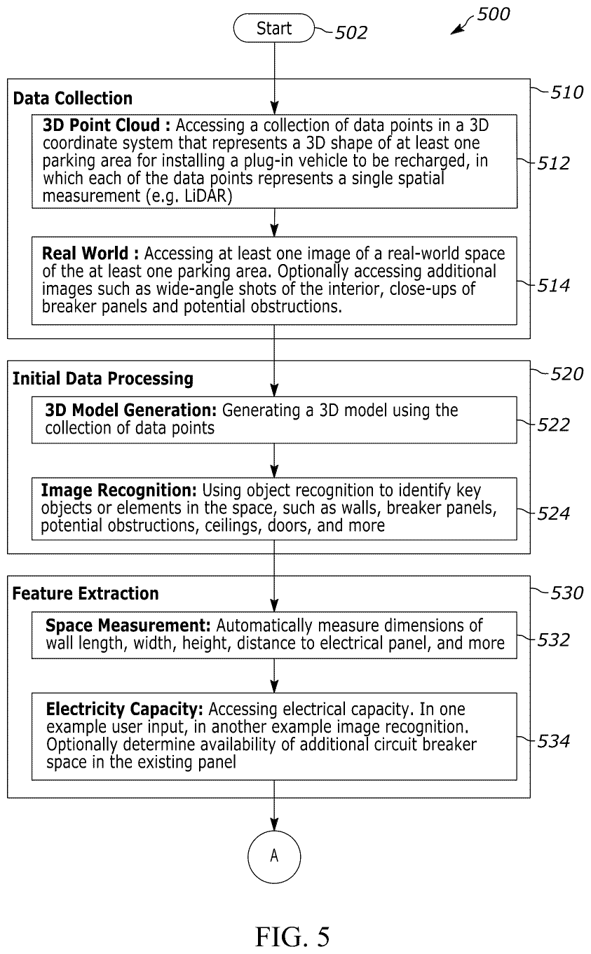

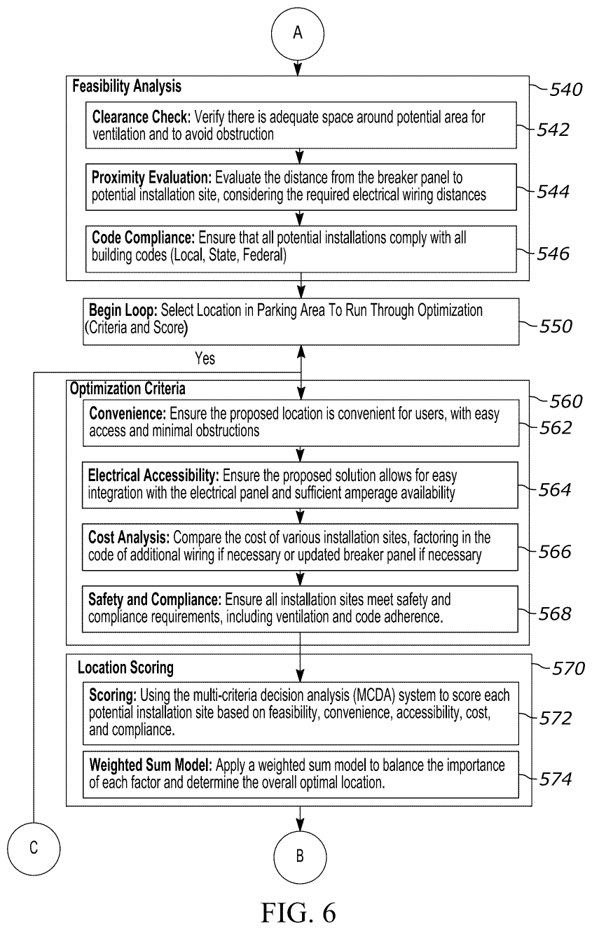

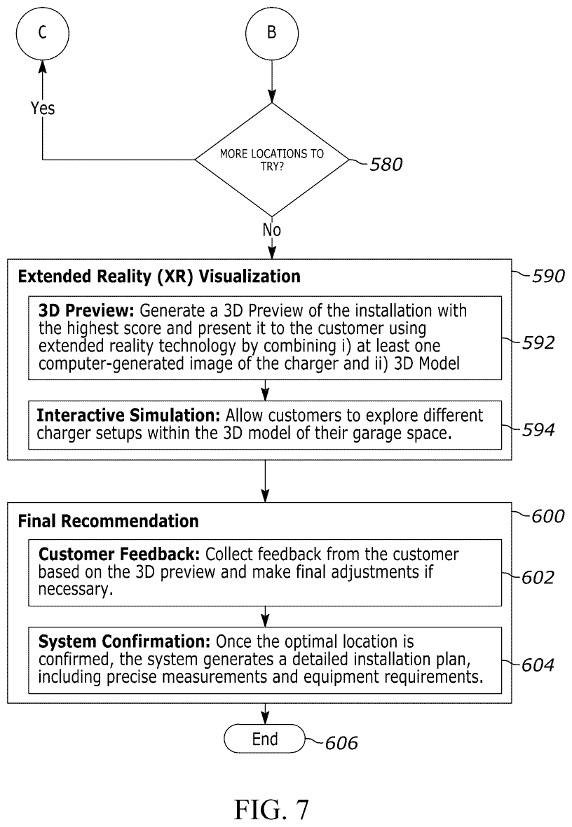

FIG. 5, FIG. 6, and FIG. 7 depict a process flow 500 for guided EV charging installation. The process begins at step 502 and proceeds to data collection 510 as the first major step. The first sub-step is data collection using 3D point cloud 512. The data collection is in a 3D coordinate system that represents a 3D shape of at least one parking area for installing an EV vehicle. The data points represent a single spatial measurement (e.g., LiDAR) is accessed. The second sub-step is accessing at least one image of the real-world space 514 of the parking area. Additional images of the real-world space may include wide-angle shots, electrical panel close-ups, obstruction images, existing electrical setup, and more. The process continues to a second major step, initial data processing 520.

The initial data processing 520 step includes two sub-steps. The first sub-step is 3D model generation 522, in which a 3D model is generated using the collection of data points. Examples of software packages that create 3D models from point clouds include Autodesk Recap, MeshLab, CloudCompare, Trimble RealWorks, Leica Cyclone, or SketchUp. The second sub-step is image recognition 524. Image recognition is used to identify key objects or elements in the space, such as walls, electrical panels, potential obstructions, ceilings, doors, and more. Examples of image recognition software includes Google Lens, Microsoft Lens, Greenshot, TinEye, and others. The process continues to a third major step, feature extraction 530.

Feature extraction 530 step includes two sub-steps. The first sub-step is space measurement extraction 532. In this sub-step, dimensions of wall spaces, clearance distances, and electrical panel proximity are automatically measured/calculated using the 3D model. Most 3D modeling software listed above for step 522 includes an ability to measure distances between points in a 3D model. The second sub-step is electrical capacity extraction 534. Close-up images of the electrical panel with the panel door open and closed are analyzed in response to user input or using image recognition or both, to determine available electrical capacity and panel accessibility. Electrical capacity includes the maximum amperage the electrical panel can accommodate along with any available space i.e., number of slots and size, to add circuit breakers. The process continues to a fourth major step, feature analysis 540.

Feature analysis 540 step includes three sub-steps. The first sub-step is clearance check analysis 542. Several critical clearance distance checks are verified, including whether there is adequate space around a potential area for ventilation and to avoid obstruction to the EV charger and the EV vehicle charging port. The second sub-step is proximity evaluation analysis 544. The distance from the electrical panel to a potential installation site is evaluated. This distance may be used to calculate the required electrical wiring distances. The third sub-step is code compliance analysis 546. All local, state, and Federal building codes are reviewed for compliance to ensure that all potential installations comply with all building codes and ordinances. The process continues to a fifth major step, loop 550.

This loop 550 selects a location in the parking area to run through optimization criteria and scores. This is represented by two major steps of optimization criteria 560 and location scoring 570.

Optimization criteria 560 includes four sub-steps. The first sub-step is convenience criteria 562 for determining if a proposed location is convenient for users. The determination includes the height and position of the EV charger to ensure easy access and minimal obstructions. The position of the charger port, e.g., driver side, passenger side, front, rear, on the EV vehicle, may also be considered. The second sub-step is electrical accessibility criteria 564 for determining if a proposed solution allows for easy integration with the electrical panel. Integration includes available space for additional circuit breakers, i.e., number of slots and size, sufficient amperage, and electrical wire routing between the electrical panel and the EV charger. The process continues to the third sub-step, cost analysis criteria 566. The cost analysis criteria 566 compares the costs of various installation sites, factoring in the cost of additional wiring, additional circuit breakers, and replacement or auxiliary electrical panel if necessary. The process continues to a fourth sub-step, safety and compliance criteria 568. The safety and compliance criteria 568 ensures that all installation sites meet safety and compliance requirements, including ventilation and adherence to local, state, and federal codes. The process continues to the second major step location scoring 570 in the loop 550.

The location scoring 570 includes two sub-steps. The first sub-step is scoring 572 Scoring 572 uses a multi-criteria decision analysis (MCDA) system to score each potential installation site based on feasibility, convenience, accessibility, cost, and compliance. The process continues to the second sub-step, weighted sum model 574. A weighted sum model 574 may be used to balance the importance of each factor and determine the overall optimal location using an overall score. In another embodiment, all the weights are equal and just a sum may be used. The factors used for scoring include the distance between the electrical panel or breaker panel and the EV charger, an estimated cost based on the amount of wiring required to traverse this breaker distance, and the clearance distance between the evaluation position and surrounding identified objects. Other factors may also be used. The process continues to decision point 580.

Decision point 580 is a test to determine if there are any remaining locations to try. . . . If there are more locations to try, the process loops back up to the optimization criteria 560. Otherwise, the loop terminates because there are no more locations to try and continues to extended reality (XR) visualization 590. In another example, the number of times the process loops may be set by a number of distinct locations to try, or setting a computational time period, for example, run the simulation for five minutes.

Extended Reality (XR) Visualization 590 includes two sub-steps. The first sub-step is 3D preview 592. The 3D preview generates a 3D preview of the top-ranked installation location and presents it to the customer for review using extended reality technologies. The process continues to the second sub-step, interactive simulation 594. Interactive simulation 594 allows customers to explore different charger setups within the 3D model of their garage space. The process continues to final recommendation 600.

Final recommendation 600 includes two sub-steps. The first sub-step is customer feedback 602. The customer feedback 602 collects feedback from the customer based on the 3D preview and makes any necessary final adjustments to the previously calculated overall scores. The second sub-step is system configuration 604. System confirmation 604 generates a detailed installation plan, including precise measurements and equipment requirements, once the optimal, near-optimal, or desired location based on customer feedback is confirmed. The process ends in step 606.

### Computer Hardware

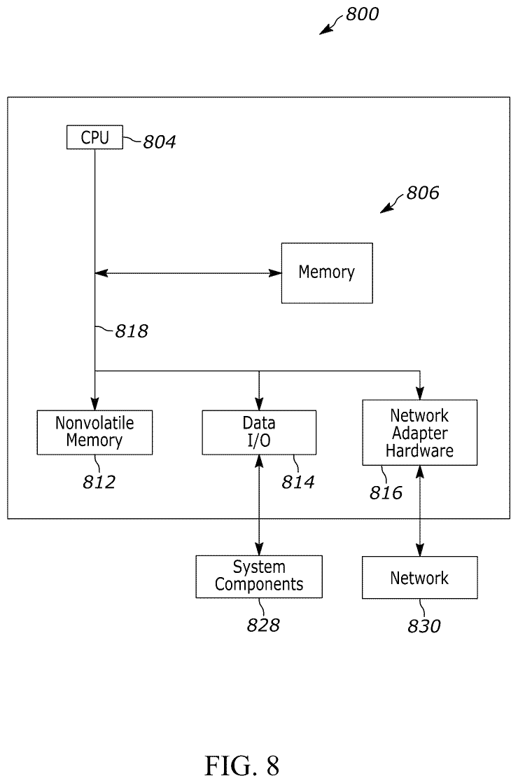

FIG. 8 depicts a block diagram illustrating a processor 800 according to an example. The processor 800 is an example of a processing subsystem that is able to perform any of the above-described processing operations, control operations, other operations, or combinations of these.

The processor 800 in this example includes a CPU 804 that is communicatively connected to a main memory 806 (e.g., volatile memory), and a non-volatile memory 812 to support processing operations. The CPU 804 is further communicatively coupled to a network adapter hardware 816 to support input and output communications with external computing systems such as through the illustrated network 830.

The processor 800 further includes a data input/output (I/O) processor 814 that can be adapted to communicate with any type of equipment, such as the illustrated system components 828. The data input/output (I/O) processor, in various examples, can be configured to support any type of data communications connection, including present-day analog and/or digital techniques or via a future communications mechanism. A system bus 818 interconnects these system components.

### Information Processing System

The present subject matter can be realized in hardware, software, or a combination of hardware and software. A system can be realized in a centralized fashion in one computer system or in a distributed fashion where different elements are spread across several interconnected computer systems. Any kind of computer system—or other apparatus adapted for carrying out the methods described herein—is suitable. A typical combination of hardware and software could be a general-purpose computer system with a computer program that, when being loaded and executed, controls the computer system such that it carries out the methods described herein.

The present subject matter can also be embedded in a computer program product, which comprises all the features enabling the implementation of the methods described herein, and which-when loaded in a computer system-is able to carry out these methods. Computer program in the present context means any expression, in any language, code, or notation, of a set of instructions intended to cause a system having an information processing capability to perform a particular function either directly or after either or both of the following a) conversion to another language, code or, notation; and b) reproduction in a different material form.

Each computer system may include, inter alia, one or more computers, and at least a computer-readable medium allowing a computer to read data, instructions, messages or message packets, and other computer-readable information from the computer-readable medium. The computer-readable medium may include computer-readable storage medium embodying non-volatile memory, such as read-only memory (ROM), flash memory, disk drive memory, CD-ROM, and other permanent storage. Additionally, a computer medium may include volatile storage such as RAM, buffers, cache memory, and network circuits. Furthermore, the computer-readable medium may comprise computer-readable information in a transitory state medium such as a network link and/or a network interface, including a wired network or a wireless network, that allows a computer to read such computer-readable information. In general, the computer-readable medium embodies a computer program product as a computer-readable storage medium that embodies computer-readable program code with instructions to control a machine to perform the above-described methods and realize the above-described systems.

### Non-Limiting Examples

Although specific embodiments of the subject matter have been disclosed, those having ordinary skill in the art will understand that changes can be made to the specific embodiments without departing from the spirit and scope of the disclosed subject matter. The scope of the disclosure is not to be restricted, therefore, to the specific embodiments, and it is intended that the appended claims cover any and all such applications, modifications, and embodiments within the scope of the present disclosure.

Although specific embodiments of the invention have been discussed, those having ordinary skill in the art will understand that changes can be made to the specific embodiments without departing from the scope of the invention. The scope of the invention is not to be restricted, therefore, to the specific embodiments, and it is intended that the appended claims cover any and all such applications, modifications, and embodiments within the scope of the present invention.

It should be noted that some features of the present invention may be used in one embodiment thereof without the use of other features of the present invention. As such, the foregoing description should be considered as merely illustrative of the principles, teachings, examples, and exemplary embodiments of the present invention and not a limitation thereof.

Also, these embodiments are only examples of the many advantageous uses of the innovative teachings herein. In general, statements made in the specification of the present application do not necessarily limit any of the various claimed inventions. Moreover, some statements may apply to some inventive features but not to others.

The description of the present invention has been presented for purposes of illustration and description and is not intended to be exhaustive or limited to the invention in the form disclosed. Many modifications and variations will be apparent to those of ordinary skill in the art without departing from the scope and spirit of the described embodiments. The embodiment was chosen and described in order to best explain the principles of the invention and its practical application and to enable others of ordinary skill in the art to understand the invention for various embodiments with various modifications as are suited to the particular use contemplated. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method for evaluating an EV charging station installation in an extended reality space, the method comprising:
accessing a collection of data points in a 3D coordinate system that represents a 3D shape of at least one parking area for installing an EV vehicle to be recharged, wherein each of the data points represents a single spatial measurement;
accessing at least one image of a real-world space of the at least one parking area;
using object recognition to identify one or more surrounding objects in the at least one image, the one or more surrounding objects including one or more walls, an electrical panel, and a ceiling;
measuring dimensions of the one or more walls and relative distance to the electrical panel;
accessing an electricity capacity of the electrical panel;
creating a set of potential positions along the one or more walls that have been identified in the image;
placing a charger station in an evaluation position in the set of potential positions to associate the evaluation position with an overall score by:
calculating a breaker distance between the evaluation position and the electrical panel;
estimating a cost based on an amount of wiring required to traverse the breaker distance between the evaluation position and the electrical panel;
calculating a clearance distance between the evaluation position and the one or more surrounding objects;
storing the breaker distance, the cost, and the clearance distance as a set of overall scores associated with the evaluation position;
identifying a highest overall score in the set of overall scores;
generating a 3D preview of the evaluation position associated with the highest overall score using extended reality technology by combining i) at least one computer-generated image of the charger station and ii) the data points in the 3D coordinate system; and presenting to a user the 3D preview.

2. The computer-implemented method of claim 1, further comprising:
using LiDAR to capture the collection of data points in a 3D coordinate system.

3. The computer-implemented method of claim 1, wherein the creating a set of potential positions along the walls that have been identified in the image includes removing from the set any potential positions, the potential positions ineligible to meet:
a clearance requirement for the charger at the potential position;
an electrical requirement for the charger at the potential position; or
a combination of both.

4. The computer-implemented method of claim 3, wherein the electrical requirement further includes:
an amperage capacity of an electrical panel;
a number and size of available circuit breaker locations in the electrical panel; or
a combination thereof.

5. The computer-implemented method of claim 4, further comprising:
using image object detection on the image of the real-world space and a 3D shape to identify a model of the electrical panel; and
using the model to retrieve the amperage capacity of the electrical panel.

6. The computer-implemented method of claim 4, further comprising:
accessing at least one image of a real-world space of the electrical panel with a door to the electrical panel in an open position; and
using image object detection on the image of the real-world space of the electrical panel with the door to the electrical panel in an open position to determine a number and size of available breaker locations.

7. The computer-implemented method of claim 1, wherein the placing the charger station in the evaluation position in the set of potential positions to associate the evaluation position with the overall score further includes:
calculating a parking distance between the evaluation position and the at least one parking space; and
wherein the identifying the overall score as the highest score, in the set of overall scores, is further based on the parking distance.

8. The computer-implemented method of claim 1, further includes:
presenting the requirements related to the EV charging station installation that is customized based on the collection of data points of the at least one parking area including:
a first set of requirements related to the EV charging station installation at a first position in the at least one parking area;
calculating an associated cost for the requirements related to EV charging station installation in the first position of the at least one parking area;
the first set of requirements related to the EV charging station installation at a second position in the at least one parking area; and
calculating an associated cost for the requirements related to EV charging station installation in the second position of the at least one parking area.

9. The method of claim 1, wherein the using object recognition to identify the one or more surrounding objects in the at least one image includes receiving input from a user labeling at least one of the one or more surrounding objects in the at least one image.

10. A system for evaluating an EV charging station installation in an extended reality space, the system comprising:
a computer memory capable of storing machine instructions; and
a hardware processor in communication with the computer memory, the hardware processor configured to access the computer memory to execute the machine instructions for performing:
accessing a collection of data points in a 3D coordinate system that represents a 3D shape of at least one parking area for installing an EV vehicle to be recharged, wherein each of the data points represents a single spatial measurement;
accessing at least one image of a real-world space of the at least one parking area;
using object recognition to identify one or more surrounding objects in the at least one image, the one or more objects including one or more walls, an electrical panel, and a ceiling;
measuring dimensions of the one or more walls and relative distance to the electrical panel;
accessing an electricity capacity of the electrical panels;
creating a set of potential positions along the one or more walls that have been identified in the image;
placing a charger station in an evaluation position in the set of potential positions to associate the evaluation position with an overall score by
calculating a breaker distance between the evaluation position and the electrical panel;
estimating a cost based on an amount of wiring required to traverse the breaker distance between the evaluation position and the electrical panel;
calculating a clearance distance between the evaluation position and surrounding objects;
storing the breaker distance, the cost, and the clearance distance as a set of overall scores associated with the evaluation position;
identifying a highest overall score in the set of overall scores;
generating a 3D preview of the evaluation position associated with the highest overall score using extended reality technology by combining i) at least one computer-generated image of the charger station and ii) the data points in the 3D coordinate system; and
presenting to a user the 3D preview.

11. The system of claim 10, further comprising:
using LiDAR to capture the collection of data points in a 3D coordinate system.

12. The system of claim 10, wherein the creating a set of potential positions along the walls that have been identified in the image includes removing from the set any potential positions, the potential positions ineligible to meet
a clearance requirement for the charger at the potential position
an electrical requirement for the charger at the potential position; or
a combination of both.

13. The system of claim 12, wherein the electrical requirement further includes
an amperage capacity of the electrical panel;
a number and size of available circuit breaker locations in the electrical panel; or
a combination thereof.

14. The system of claim 13, further comprising:
using image object detection on the image of the real-world space and a 3D shape to identify a model of the electrical panel; and
using the model to retrieve the amperage capacity of the electrical panel.

15. The system of claim 13, further comprising:
accessing at least one image of a real-world space of the electrical panel with a door to the electrical panel in an open position; and
using image object detection on the image of the real-world space of the electrical panel with the door to the electrical panel in an open position to determine a number and size of available breaker locations.

16. The system of claim 10, wherein the placing the charger station in the evaluation position in the set of potential positions, to associated the evaluation position with an overall score further includes
calculating a parking distance between the evaluation position and the at least one parking space; and
wherein the identifying the overall score as the highest score, in the set of overall scores, is further based on the parking distance.

17. The system of claim 10, further comprising:
presenting the requirements related to the EV charging station installation that is customized based on the collection of data points of the at least one parking area, includes
presenting a first set of requirements related to the EV charging station installation at a first position in the at least one parking area;
calculating an associated cost for the requirements related to EV charging station installation in the first position of the at least one parking area;
presenting the first set of requirements related to the EV charging station installation at a second position in the at least one parking area; and
calculating an associated cost for the requirements related to EV charging station installation in the second position of the at least one parking area.

18. The system of claim 10, wherein the using object recognition to identify the one or more surrounding objects in the at least one image includes one of receiving input from a user labeling the one or more surrounding object in the at least one image.
